(19) United States
(12) Patent Application Publication
(10) Pub. No.: US 2004/0230440 A1
(43) Pub. Date: Nov. 18, 2004

(54) System for automating purchase recommendations

(76) Inventor: Anil Malhotra, Atlanta, GA (US)

Correspondence Address: Jason A. Bernstein, Bernstein & Associates, P.C., 16TH FLOOR, 191 PEACHTREE STREET, N.E., Atlanta, GA, 30303-1736, US

(21) Appl. No.: 10/600,283

(22) Filed: Jun. 20, 2003

Related U.S. Application Data
(60) Provisional application No. 60/390,292, filed on Jun. 21, 2002.

(51) Int. Cl. G06F 17/60

(52) U.S. Cl. 705/1

(57) ABSTRACT

A purchase recommendation system for selected items by a user via a human speech platform. The human speech platform is in communication with the user via any type of communication media. Further, the human speech platform is in communication with a computer system having stored thereon at least one program to receive, translate and select a recommendation for the purchase of an item based on a correlation of predetermined attributes of selected items for purchase and selected attributes derived from the user at the incident of purchase. The user, after receiving the recommendation for the purchase of an item may, if desired, accept or reject the recommendation. If the user accepts the recommendation, the transaction is complete. If the user rejects the recommendation, the user may, if desired, receive a subsequent recommendation for the purchase of an item via a selected program from the computer system.

### CROSS-REFERENCE TO RELATED APPLICATION

This application claims the benefit of U.S. Provisional Application No. 60/390,292 filed on Jun. 21, 2002, entitled “SYSTEM AND METHOD FOR AUTOMATING THE DELIVERY OF CUSTOMIZED PURCHASE RECOMMENDATIONS RELATED TO THE SALE OF PRODUCTS USING A WEB BASED VOICE RECOGNITION SYSTEM”, and commonly assigned to the assignee of the present application, the disclosure of which is incorporated by reference in its entirety herein.

### FIELD OF THE INVENTION

The invention relates in general, to Internet based information filtering and recommendation systems. In particular, the invention relates to an automated purchase delivery system of customized purchase recommendations related to the sale of products using a Web-based voice recognition system.

### BACKGROUND OF THE INVENTION

One technique commonly used in e-commerce purchase recommendation systems is content-based filtering. In a pure content-based filtering system, recommendations are based upon similarities between the product features and the feature preferences of the purchaser. Pure content-based filtering systems used for e-commerce purchase recommendations have several limitations. First, they require the product to have distinguishable features that can be easily separated from the product in order to assess its similarity to the user's preferences. Second, because of the “feature extraction” requirement, pure content-based systems are not well suited for the recommendation of products with subjective features like music.

A second commonly used technique is collaborative filtering. In pure collaborative filtering purchase recommendation systems, suggestions are made to users based on what products other users with similar preferences found relevant. This system does not make accommodation for the specific features of the product as is the case in content based filtering systems. Collaborative filtering systems are commonly based on a set of user ratings. Each user rates a set of products themselves in order to establish these ratings. Through this process, each user develops a ratings profile. Comparing profiles and extracting products that have not been rated by one user or another generate the recommendations. These yet “unrated” products are recommended to user who have similar profiles.

As with content based filtering systems, collaborative filtering systems have their own set of limitations. The first limitation relates to the building of the ratings database. Since each user actually provides their personal ratings for a given set of products, the process of building a personal ratings profile can be time consuming. This process becomes even more cumbersome if users are not very familiar with some of the products that they are asked to rate. In addition, since collaborative systems work by relating users with similar tastes, the system does not work very well for users that have unusual tastes.

Another major issue is that collaborative filtering systems cannot recommend a product until it has been rated. At the launch of a new collaborative filtering system, since no products have been rated yet, the system cannot function at an optimal level until sometime in the future when a minimum level of ratings data is accumulated.

The corollary of the previous challenge is that once a very large database of user rating profiles is established, collaborative filtering systems tend to trade off efficiency for effectiveness. This occurs because the recommendation engine is required to compare a large volume of ratings profiles. In order to provide timely recommendations, the system will have to limit the number of profiles that are compared. This limitation, while enabling the system to deliver recommendations in a timely manner, will allow provide recommendations based on a limited analysis of the available data. This will increase the possibility of poor recommendations.

Finally, because collaborative systems are based strictly on the comparison of ratings profiles, there is no accommodation made for a user's request for a specific category of item. In addition, since all products are treated with the same “weight”, there can be no preference given to items that have been selling very well—only items that have been rated very well.

### SUMMARY OF THE INVENTION

The present invention has the ability to communicate with the user, not through text and graphics, but through voice commands and audio prompts. This feature is enabled with voice recognition and web technologies. This feature does not limit communication to desktop computers but allows the user to access the service via any telephone. Voice commands and audio prompts may, if desired, be implemented via a system comprising a speech application platform, core speech software and servers, a telephony interface, application servers and databases.

One aspect of the present invention is a product database. This database is designed with content layers and rating layers to facilitate the recommendation process. In an exemplary embodiment related to music: every ticket package is sub-divided into individual events; every event is sub-divided into individual pieces of music; and, individual pieces of music are sub-divided into individual attributes (such as composer, conductor, featured instrument). Finally, the system manager rates each attribute. This data structure allows for both content-based filtering and collaborative filtering, directly compensating for many of the limitations of pure content based filtering systems and pure collaborative filtering systems.

The present invention may, if desired, have a Parallel Database that has data structures for creating relationships between similar composers (or other key attributes). These data structures may, if desired, be used in the event that the user's preferences do not match with any of the existing product attributes or the user has declined all prior recommendations and no further matches exist.

One method that leverages this overall data structure uses content-based filtering to match user product preferences to the existing data structure that contains the parsed product features. When a user initiates a call with the recommendation system, the user will be required to input their product feature preferences. The user will input (using their voice) their preferences and the system will compare these preferences to the parsed product features that make up the data structure. This type of filter creates a very user-friendly interface for gathering product preferences.

The second method that leverages the data structure uses collaborative filtering techniques, to quantitatively address the more subjective issues that arise when considering product recommendations. Prior to the launch of the service, ratings are assigned to subjective aspects of each product attribute. For example—in an exemplary embodiment related to tickets for musical performances, how popular is a particular conductor? When matches are found in the content based filtering process, the rating for that matching attribute is used to compare and rank the various events and by extension, each ticket package. The highest ranked event or package is presented to the user.

The present invention returns recommendations that have considered exact feature matches as well as a predetermined set of quantitative ratings that can more specifically address subjective aspects such as popularity. Further, the present invention integrates the user's feedback from the initial product recommendation into a second round of product recommendations. For example: If the patron does not like the selection of events that feature a specific composer (in an exemplary embodiment related to music), the system can make additional recommendations that factor this dislike into the process.

The present invention addresses the above limitations of pure content based filtering systems and pure collaborative filtering systems. These combined limitations are addressed through the present invention that is based on a hybrid content-collaborative based filtering system to provide recommendations to users of an internet voice recognition based recommendation service. The present invention may, if desired, be used to generate performing arts event ticket purchase recommendations to users of a voice recognition based ticket service. Users of the present invention may, if desired, input their preferences with regards to their prospective ticket purchase by using their voice. The user's preferences would be matched against the features of the available events and event packages and an appropriate list of recommendation(s) would be presented to the user over the phone by the automated system. After which the user can provide further feedback on the presented recommendations and refine the list of possible purchase items. This entire system is managed by a web based computer application that communicates with the user via voice recognition.

### BRIEF DESCRIPTION OF THE DRAWINGS

FIG. 1 illustrates a top level block diagram of the present invention,

FIG. 2 illustrates a top level flowchart diagram of the call flow of FIG. 1,

FIG. 3 illustrates a flowchart diagram of a user who wants to purchase a ticket of FIG. 1,

FIG. 4 illustrates a flowchart diagram of a method of sorting and presenting the appropriate recommendations to the caller of FIG. 2,

FIG. 5 illustrates a flowchart diagram combining the content based filtering techniques with the collaborative filtering techniques to return a list of customized purchase recommendations,

FIG. 6 illustrates a schematic diagram of the data structure fields of FIG. 1,

FIG. 7 illustrates a flowchart diagram of order confirmation of FIG. 1,

FIG. 8 illustrates a flowchart diagram of determining the most suitable upgrade offer.

### DETAILED DESCRIPTION OF THE INVENTION

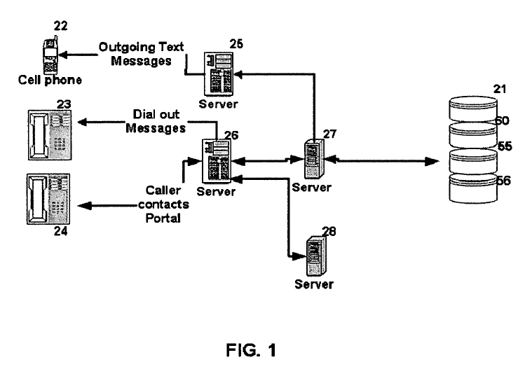

FIG. 1 outlines the technical structure and components that will host and serve this Internet based system. 24 indicates the initiation of contact between the user and the system. 26, the voice application platform, will manage the contact with the user. It will receive the voice input from the user and will return pre-recorded audio responses/content back to the user. This server will communicate with two back end servers: 27 that will control administrative, organizational and patron activity & 28 that will control the static content such as the audio files. These servers will supply the voice application platform with the appropriate audio content. 27 will run Iplanet Enterprise Web Server 6.0 (web server) and BEA Weblogic Server (application server). Because of the types of functions that will be required of 28, it will only be required to run Iplanet Enterprise Web Server 6.0. This software configuration is only one possible configuration. There are other widely available servers that would be acceptable. The database, 60, 55, 56, will host all the details on the programming such as event dates, features, attribute scores, the Parallel database as well as patron data such as name, address, phone number and past purchase history. 60, 55, 56 will run off an Oracle 8i database server. All servers will run off the Solaris 2.6 operating system. This software configuration is only one possible configuration. 21 represent the ticketing system that contains all of the seating arrangements and available seats for each of the events that are available for sale. These data structures will be accessed as needed depending upon the requirements of each incoming phone call. For example, not all phone calls will require access to information on the patron database or the ticket system. 22 & 23 represent the system's ability to send outgoing text messages (22) and automated pre-recorded phone calls (23). 25 represents the server that will send out text messages to mobile phones.

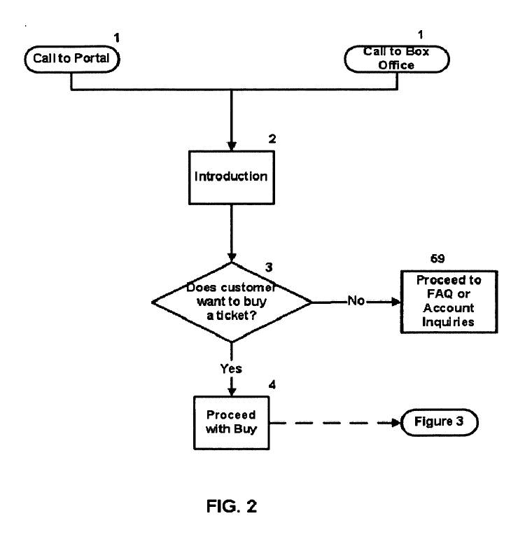

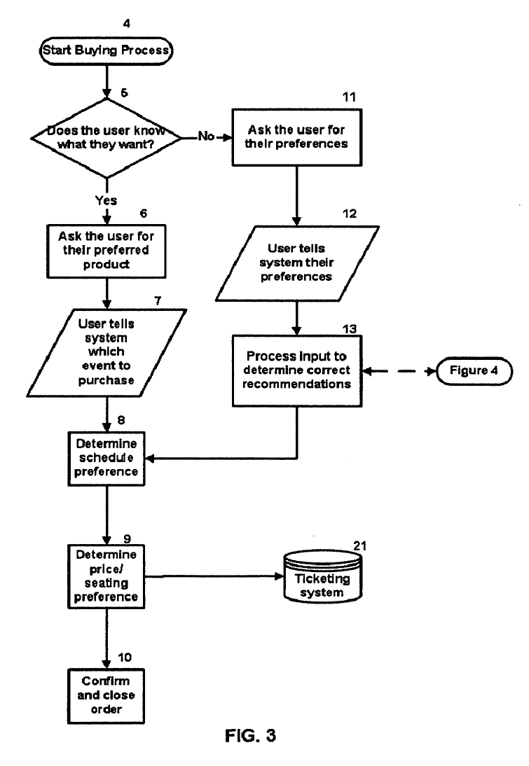

In FIG. 2, 1 illustrates the means by which a user can connect to the system. This system is designed to be accessed by phone. The user communicates with the system though the use of voice recognition. This means that the user is prompted for information with pre-recorded audio files. The user simply responds with his/her voice. The voice recognition software communicates with other parts of the system to facilitate the ticket purchase. The user can connect by either calling the central portal phone number or can call the box office phone number of the desired venue directly. Both phone calls will be directed to this system. The “portal phone number” refers to an 800-number that accesses the system from anywhere in the United States. The “box office phone number” refers to a local phone number that a ticketing organization utilizes for its in-city box office operations. The use of two phone numbers is a convenience for the user. 2 depicts the greeting or greetings that the user will receive when first contacting the service. The type or types of greetings will be dependent upon which phone number the user contacts. The “greeting” refers to a pre-recorded audio file that is played for the user offering instruction on how to use the system and asking the user how they would like to proceed. In one exemplary embodiment, a unique user ID may, if desired, be established using either a patron number, phone number or a voice print during the Introduction phase. A voice print is “a unique audio pattern that is created by the sound of a person's voice”. After completing the introduction and establishing a unique user ID for the caller, the system prompts the caller about their desired next step. 3 indicates the prompting of the user with a choice as to how to proceed with the remainder of the call. This prompt refers to a pre-recorded audio file that is played for the user asking them if they would like to purchase a ticket (4), or, in 59, receive answers to some frequently asked questions (FAQ's) or make an inquiry into their account (such as changing their mailing address or verifying the delivery of recently purchased tickets). The steps involved in buying tickets at 4 are described in more detail in FIG. 3 and in the detailed description below.

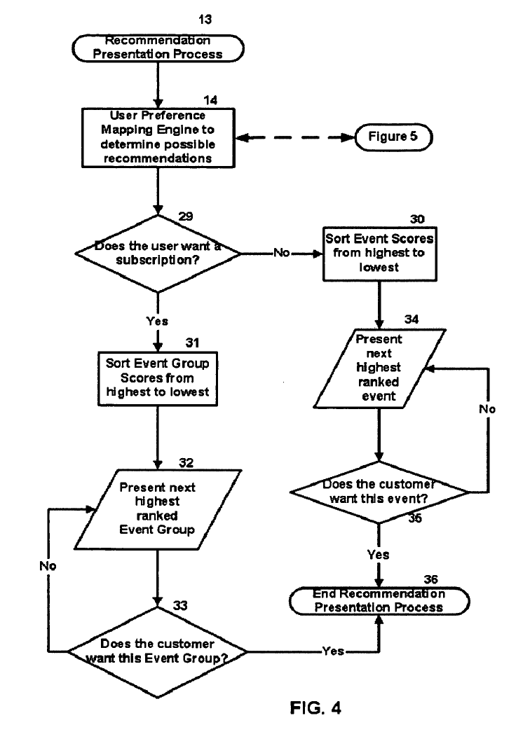

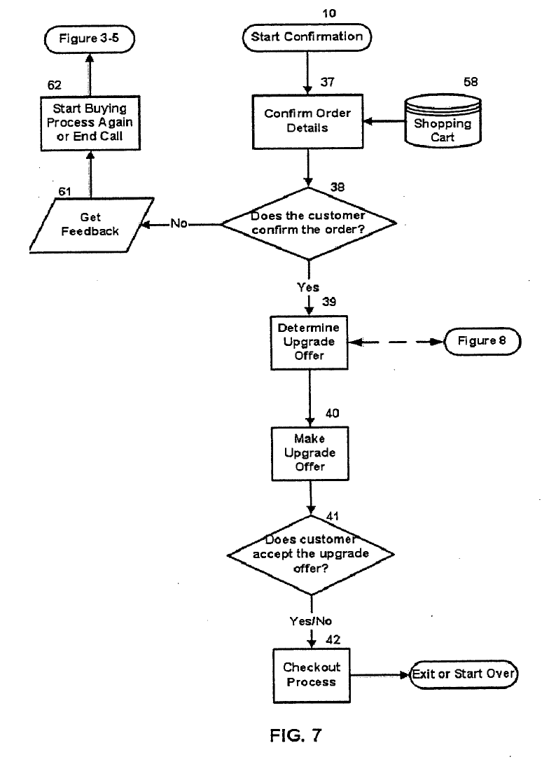

The buying process 5, FIG. 3 determines if the user knows exactly which product they would like to purchase. Following the “Yes” branch leading from 5 implies that the user has initiated a call to this system for the purposes of purchasing a ticket to a specific pre-determined event (the user already knows what they want to purchase). This step begins at 6 with a pre-recorded audio file that asks the user which event he/she would like to attend. The voice input from the user is recognized by the voice recognition system in 7 and is stored in the system's memory. 11-13 involves prompting the user for their preferences, if they don't know exactly what they want to purchase. 11 involves explicitly asking the user for his/her preferences as they relate to a product. In one exemplary embodiment, preferences can relate to attributes of music concerts such as composers, conductors, guest artists, favorite instrument, pieces of music or time of the year. The system receives the user's voice input in 12. Next, the system compares user's preferences to the attributes of the available concerts and offers a customized set of purchase recommendations (13), which is discussed in more detail below with respect to FIG. 4. Once the exact product is confirmed through interaction with the user, 8-10 confirms the remaining details of the order. 8 represent a confirmation of the preferred day of the week for attendance. 9 represent confirmation of the seating choice for the user. 10 represent the steps required to complete the order. These steps are discussed more fully below with respect to FIG. 7-42. The updated seating and pricing data is stored in a separate data structure, usually in the form of a web based ticketing system, as depicted in 21.

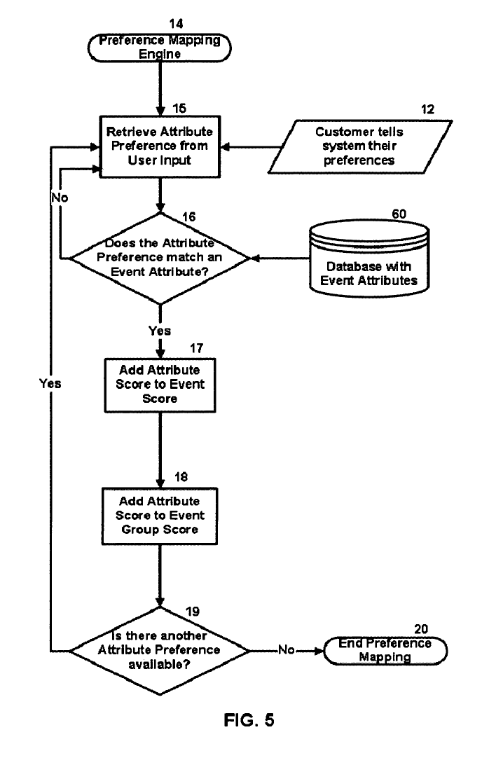

FIG. 4 illustrates a high-level overview of the method for determining possible product recommendations and presenting select product recommendations based on their score. After conducting the preference mapping process in 14 for which further details will be discussed below with respect to FIG. 5, the next step, 29, is to determine the type of ticket product the user would like to purchase: a subscription or a single event ticket. A “subscription” refers to a pre-determined package of events that must be purchased as a group also referred to below as Event Group. All the possible options (both subscription and single event) were ranked from highest to lowest according to their Event Group Scores (defined below) and Event Scores (defined below) in 31 & 30 respectively. For either of these options, the system presents the highest ranked option, in 32 & 34. The presentation of options continues until the user accepts one of the options in 33 & 35. 36 represent the end of the recommendation presentation process.

Other possible applications of this system beyond those related to symphony orchestra ticketing include: ticket sales of opera performances, live theater performances, ballet performances, museum exhibits, live popular music performances and other non-arts/non-performance related applications including but not limited to professional baseball, football, hockey and basketball.

FIG. 5 illustrates the method for mapping a user's preferences over top of a predetermined set of product options. This method utilizes both content based filtering techniques (FIG. 5-16) as well as collaborative filtering techniques (FIG. 5-17, FIG. 5-18). In 15, the system retrieves each attribute preference that was inputted by the user. In 16, each event attribute is compared to each event attribute in the event data structure, 60. 16 is therefore utilizing content-based filtering because it creates an initial group of possible product recommendations by comparing the similarities between the users' preferences and the product features. 17 and 18 are, in turn, and as more fully described below, utilizing collaborative-based filtering techniques, because they work together to quantify the possible product recommendations by matching a current user's product preferences of certain product attributes with a pre-existing set of product ratings created by those with expert knowledge in a particular field of the embodiment. Therefore, 16, 17, and 18 work in tandem to provide the benefits of content-based filtering and collaborative-based filtering, while at the same time accommodating for the shortfalls inherent in each process. Throughout the entire process, content-based filtering and collaborative-based filtering respond to user input, as discussed above, using a web based voice recognition system.

To achieve the result of content-based filtering and collaborative-based filtering working in tandem, using a web based voice recognition system, certain “scores” are used to by the system to assign value to users' preferences and ratings. Thus, in an exemplary embodiment related to music performances, RS refers to the Relevance Score, which denotes the relevance of a particular attribute to the evening's performance. In an exemplary embodiment, attributes are given a score of 0-3. A score of “0” represents the lowest and “3” represents the highest. For example even though Mozart is a very prominent composer, some of his pieces are very short and may not be the featured piece being played that evening—it may lack “relevance” to the evening and would likely get a score of 1.

PS refers to the Prominence Score. This particular score denotes the prominence of the attribute to the classical music world as a whole. In an exemplary embodiment, attributes are given a score of 0-3. A score of “0” represents the lowest and “3” represents the highest. For example, Mozart will always receive a very high prominence score but may not always receive a very high relevance score. There are some lesser-known composers who most likely always receive a low prominence score but may on occasion receive a high relevance score depending on the piece that is being performed.

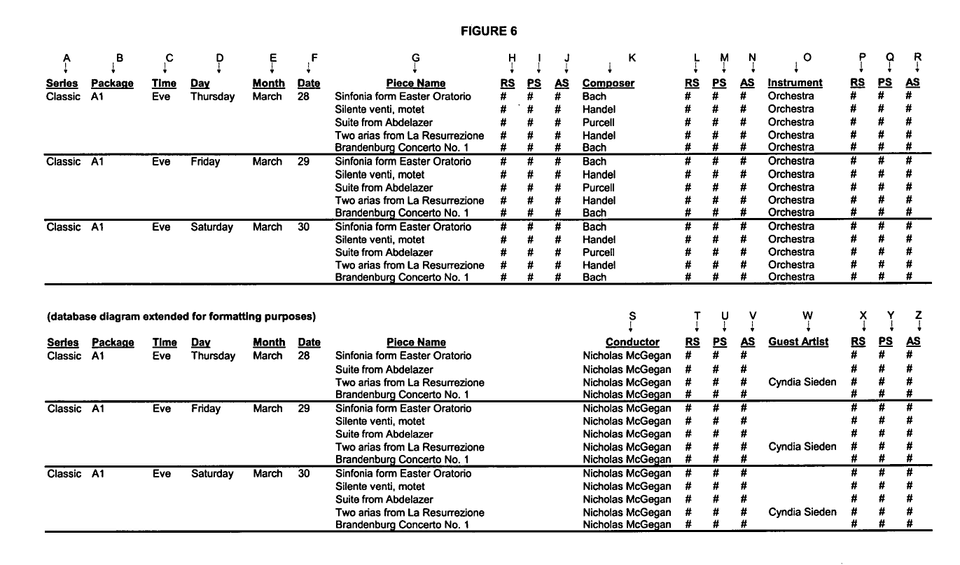

AS denotes the Attribute Score, which is defined as a quantitative representation of both the degree of prominence and the degree of relevance of a particular event attribute, and refers to the product of RS multiplied by PS. An “event attribute” is defined as a unique feature of a particular event that comprises one of the core elements of the event, in one exemplary embodiment. Generally, the event attributes are the basis upon which ticket purchasers desire to purchase one particular event instead of another event. AS is calculated for each attribute, as more fully described below with respect to FIG. 6, and provides

ES denotes the Event Score, which is defined as the sum of all the Attribute Scores that correspond to the event attributes that match the user preferences.

An Event Group is a pre-determined package of events that must be purchased as a group, also referred to above as a subscription. EGS denotes the Event Group Score, which is defined as the sum of all Event Scores within each Event Group.

In operation: The content-based filtering and collaborative-based filtering work in tandem with a web-based voice recognition system, in an exemplary embodiment relating to music performances, if a user indicated that “Beethoven” was a preference, the system, through 16, would search for a match between the user preference and the event attribute within the event data structure that contains all the event attributes (See FIG. 6). If a match is found, then the Attribute Score (AS) is added to the Event Score (ES), in 17, and to the Event Group Score (EGS), in 18. The Event Score, in FIG. 5-17, and the Event Group Score, in FIG. 5-18, form the basis of the collaborative filtering process because they work together to quantify (or score) the possible product recommendations by matching a current user's product preferences of certain product attributes with a pre-existing set of product attribute ratings created by those with expert knowledge in a particular field of the embodiment. This filtering process ranks all events and event groups based on these scores. This scoring (or rating) process enables the system to quantitatively provide recommendations to users. The result is a recommendation offered to a user via content-based filtering and collaborative-based filtering, using, as described more fully above with respect to FIG. 1.

At the beginning of a user's call into the system, ES and EGS are 0. As the system, through 16, 17, and 18, matches attributes, this number will increase. The matching process that compares a user's preferences (FIG. 3-12) to individual event attributes is referred to in FIG. 5-16 and described in more detail above. This process forms the basis of the content-based filtering process, because it provides a recommendation to a user by comparing the similarities between the users' product attribute preferences and the event attributes. The ES and EGS are quantitative measures of how closely a user's preferences match the product attributes of the available event. If no match is found between the user's preference and an event attribute, then the system will begin another mapping process with the next user preference in 19. 20 represents the end of preference mapping.

In an exemplary embodiment of the invention, the following business rules (which are electronic instructions pre-programmed into the system in order to guide the various processes) will generate the optimal ranking of options:

1. If the system finds a match between a user's “composer” or “piece of music” preference and an event attribute, the system shall add the Attribute Scores for both the composer and piece of music to the Event Score and not just the score of the matching attribute.

2. If the system finds a match between a user's “Guest Artist” or “featured instrument” preference and an event attribute, the system shall add the Attribute Scores for both the Guest Artist and featured instrument to the event Score and not just the score of the matching attribute.

These rules are necessary since there is a natural connection between the Attribute Scores of “Composer” and “Piece of Music” and of “Guest Artist” and “Featured Instrument”. For example: A user inputs a preference (in FIG. 3-12) for “Beethoven”. By stating this preference, the user is implying that they would prefer to attend a performance featuring a prominent, well-known piece of music by Beethoven. Since the Attribute Score for “Beethoven” doesn't account for the type of music that is being performed, a business rule needs to be established to account for the “Piece of Music” in the overall ranking of the recommendation options. This is accomplished by adding the Attribute Score for “Beethoven” to the Attribute Score of the “Piece of Music” in FIG. 5-17. A similar rational exists for adding the Attribute Scores for “Guest Artist” and “Featured Instrument”.

FIG. 6 is a representation of the event data structure in an exemplary embodiment related to music. This data structure forms part of the database, 21, noted in FIG. 1. This particular data structure is an example of an embodiment as it relates to symphony orchestra ticket sales. However similar data structures can be applied to other types of ticket sales, as noted above. In the cases of these additional embodiments, the equivalent event attributes would be as follows:

| Symphony Event | Opera Event | Ballet Event | Live Theater |
|---|---|---|---|
| Attributes | Attributes | Attributes | Event Attributes |
| Name of Piece | Name of Opera | Name of Ballet | Name of play |
| Composer | Composer | Composer | Playwright |
| Featured | n/a | n/a | n/a |
| Instrument | | | |
| Conductor | Director | Choreographer | Director |
| Guest Artist | Soloist(s) | Lead Dancer(s) | Lead Actor(s) |

General definitions of data structure elements:

Columns A & B: Together these two columns refer to the Event Group. In certain embodiments, there may be only one column of information representing the Event Group.

Columns C, D, E & F: These columns represent information pertaining to the date of each particular event. “C” represents the time of day. “D” represents the day of the week. “E” represents the month of the year. “F” represents day of the month.

Columns G, K, 0, S & W: These columns represent the related Event Attributes for each particular event in this exemplary embodiment. “G” represents the name of the piece of music. “K” represents the composer. “0” represents the featured instrument. “S” represents the conductor. “W” represents the guest artist.

Columns H, I, J, L, M, N, P, Q, R, T, U, V, X, Y & Z: These columns represent the Relevance Scores, Prominence Score and Attribute Scores. More detailed descriptions of these scores are noted above and below. “H, L, P, T, X” represent the Relevance Scores for their respective Event Attributes. “I, M, Q, U, Y” represent the Prominence Scores for their respective Event Attributes. “J, N, R, V, Z” represent the Attribute Scores for their respective Event Attributes.

For example: An event from the “Classic A1” Concert Group is being performed on Thursday March 28. It features the piece “Sinfonia from Easter Oratario” by “Bach”. This composition is an “Orchestral” piece being conducted by “Nicholas McGegan”. There is no “Guest Artist”. This example shows how the Event Attributes in the data structure are related.

In this exemplary embodiment of the data structure, each music piece is associated with its related event attributes such as conductor, composer, date, etc. The related event attributes are found by reading horizontally across the columns. The most common attributes are noted in this sample data structure but this should not be considered a complete list. Additional attributes can be easily added and integrated into the method when required. Attributes will be different for other types of performing arts organizations such as opera companies, ballet companies and theater companies (see above chart).

As discussed above with respect to FIG. 5, RS refers to the Relevance Score. This particular score denotes the relevance of this particular attribute to the evening's performance. In an exemplary embodiment, attributes are given a score of 0-3. A score of “0” represents the lowest and “3” represents the highest. For example even though Mozart is a very prominent composer, some of his pieces are very short and may not be the featured piece being played that evening—it may lack “relevance” to the evening and would likely get a score of 1.

PS refers to the Prominence Score. This particular score denotes the prominence of the attribute to the classical music world as a whole. In an exemplary embodiment, attributes are given a score of 0-3. A score of “0” represents the lowest and “3” represents the highest. For example, Mozart will always receive a very high prominence score but may not always receive a very high relevance score. There are some lesser-known composers who will likely always receive a low prominence score but may on occasion receive a high relevance score depending on the piece that is being performed.

AS denotes the Attribute Score, defined more fully above with respect to FIG. 5, and refers to the product of RS multiplied by PS. An Attribute Score (AS) is calculated for each attribute. For example the RS# in column H multiplied by the corresponding PS# in column 1 equals the resulting AS# in column J. This score is a quantitative representation of both the degree of prominence and the degree of relevance of a particular event attribute.

Multiplying the RS and PS is important to maintaining the integrity of the scoring system. Since both RS and PS are critical “dimensions” to the overall scoring of each particular attribute, having one or both of these factors rated as “0” should negate the value of the entire attribute. This result can only be generated if RS and PS are multiplied (as opposed to added). If either of these scores have a value of “0”, the resulting score AS (RS×PS) will also be “0”.

Multiplying (instead of performing some other mathematical operation) also enables the system to become a sales tool and not just an information delivery tool. In order for this system to perform a sales function, it must be able to “act” like a sales person would act. This means that it must understand what factors are important and what factors are not important from the perspective of the ticketing organization. It must also be able to offer the user accurate recommendations based on the subjective knowledge of the ticketing organization.

For example: In an exemplary embodiment related to music, a symphony might choose to assign a rating of “0” to the Prominence Score for a particular composer since this composer is unknown to most, if not all, potential patrons. Because the composer is unknown, the symphony may decide that they do not want this particular attribute to have any influence on the outcome of any potential recommendations. Because this composer does have some relevance to the evening's performance, a rating of “2” is assigned as the Relevance Score.

By multiplying these two scores we arrive at an Attribute Score of “0” (0 multiplied by 2). This score of “0” will mathematically have no bearing on the Event Score, Event Group Score or any recommendation that may be generated by the system. However, if we were adding the RS and PS (instead of multiplying them), the AS would be “2” (0 plus 2). Since the AS would be a positive number, it could have an influence on the recommendations that are made to the user (in contradiction to the wishes of the symphony orchestra).

Scores can be assigned using any kind of scale deemed necessary. The larger the rating scale, the greater the level of specificity can be established for differences between various Event Attributes. For example: a rating scale of 1-5 can be used instead of a scale of 1-3, as noted above. With a scoring range of 1-5, there are a greater number of possible Attribute Scores and therefore more opportunity to distinguish the differences between Event Attributes.

RS and PS are just two of the most common attribute measures. Additional scoring criteria can be added to further enhance the systems ability to filter subjective measures of a user's preferences.

FIG. 7 illustrates the process for completing the order. This process includes confirmation of the order as well as the determination of the upgrade offer at the end of the phone call. 37 & 38 interact with the caller to confirm the details of the product that is already in the shopping cart, represented by 58. A shopping cart is an accepted metaphor for the electronic record of the “events” that are chosen for purchase by the user. The user can recall this electronic record at any time. If, during the course of the phone session, there are events in the shopping cart that the user no longer wishes to purchase, the user can instruct the shopping cart (using a predetermined voice command) to discard that particular event. At the end of the phone session, the user is presented with all remaining events that are contained within the shopping cart. At this point, the user can choose to purchase any of the items in the shopping cart. The user will be instructed at that time with a series of steps that are required to complete the purchase. Details such as package/event, date, seating and price will be confirmed to ensure accuracy.

If the user in 38 declines to confirm the order that is presented, then a pre-recorded audio file will be played to prompt the user to provide feedback pertaining to the factors that contributed to their decision to decline the order. An example of an audio file in exemplary embodiment related to music is: “Can you please provide us with some feedback? Was it the composer, conductor, guest artist, music, featured instrument or date of the concert that prompted you to reject the order?”

In 61, the user is allowed to provide feedback to the system. In 62, the user is given the opportunity to start the buying process again or to end the call.

The business rules are applied to the confirmed order in 39 to determine the appropriate upgrade offer for this particular user. Business Rules are electronic instructions that guide the computer system. These instructions help the computer system simulate intelligent decision-making and help the computer system to decide upon a course of action in a multiple option situation. Simple business rules are generally designed with an “if X then Y” framework—where X is a current state and Y is the executable process required if the current state of X is achieved. The business rules are developed in conjunction with each ticketing organization based on their individual needs. These business rules can be customized for each deployment of the system and allow the system to react in a unique manner to each customer based on a personalized set of user information. For example, in an exemplary embodiment related to music, if a user has selected the concert “Beethoven's 9^{th} Symphony” for purchase and there is a business rule indicating that all purchasers of “Beethoven's 9^{th} Symphony” should receive 10% discount to “Tchaikovsky's 4^{th} Symphony”. Then the 10% discount offer would become one of the upgrade offers that would be considered. There is not limit on the number of mutually exclusive business rules that could be established.

40-41 continues the interaction with the user by proceeding with the explanation of the upgrade offer and the confirmation of acceptance by the user. Specific descriptions of all of the upgrade offers will be stored in pre-recorded audio files. After the exact upgrade offer is decided upon by using the business rules (as noted in the above example), the system will play the appropriate audio file that describes the chosen upgrade offer. At this point, the user will be given the opportunity to accept the upgrade offer for purchase (at which point the upgrade product will be “placed” in the shopping cart) or reject the upgrade offer. After a decision is made on the upgrade offer, all items in the shopping cart will be described to the user using a series of pre-recorded audio files. The user will then be given the opportunity to accept or reject all the items in the shopping cart. In 42, the final cost for the items that are accepted for purchase will be confirmed with the user. The user will then be asked for a mailing address and a credit card number to complete the purchase.

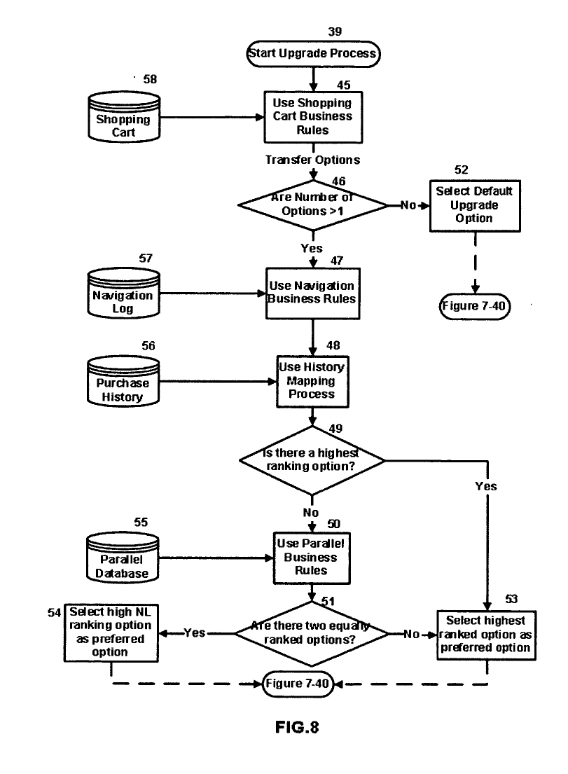

FIG. 8 illustrates the method for processing user related information to generate the optimal upgrade offer. The “optimal upgrade offer” is defined as the upgrade option that optimizes the user's current purchase information, past purchase history, navigation log and if needed a Parallel Database. This involves applying a series of business rules to the various pieces of user related information that are available—including the shopping cart, navigation log, purchase history and parallel database.

45 compares the product that is currently in the shopping cart, 58, to pre-established shopping cart business rules to determine an initial list of possible upgrade offers. Shopping cart business rules are instructions that assist the system in determining the one or more possible upgrade offers. The instructions are constructed in the “if X then Y” format. With X representing product(s) in the Shopping Cart and Y representing corresponding upgrade offer(s).

At 46, the system needs to decide how many possible upgrade options exist. If only one upgrade option exists then the default upgrade offer will be presented. The default offer is designated as such during system setup—it becomes part of the business rules.

47 will compare the user navigation log in 57 with the existing set of navigation business rules to help validate any products that the user had previously indicated were of interest. The “user navigation log” is an electronic record of all the voice inputs from the user. This includes every response that a user makes to any of the audio prompts that are generated by the system. “Navigation business rules” are instructions that guide the assessment of the available list of upgrade offers in relation to the user navigation log. A starting point is to execute a preference mapping process that would map the user's preferences (as indicated in the navigation log) over top of the available upgrade options. This mapping process would result in a “scoring” of the available upgrade options based on the matches with user's preferences. These scores are assigned to a calculation called Upgrade Option Score. The Upgrade Option Score is defined as the sum of all the Attribute Scores that correspond to the event attributes of the upgrade options that match the user preferences. The purpose of the Upgrade Option Score is defined in more detail below.

In another embodiment, a process could be implemented to map the user's dislikes over top of the available upgrade options in order to eliminate options that would likely not be desirable for the user. In order to implement this embodiment of the invention, the user would be required to offer feedback regarding each product option that was presented during the phone session. This is accomplished by pre-recording an audio file that asks the user to indicate a specific factor that contributed to their decision to not purchase a particular product option.

For example, the audio file could contain the following dialog: “Please tell us which of the following factors contributed to your decision to decline the purchase of this event(s). Was it the composer, conductor, music, guest artist, the featured instrument or the date of the event?” This audio prompt would be inserted along the “No” branch leading away from 33 & 35 in FIG. 4. The feedback offered by the user would then be registered electronically in the User Navigation Log. This information could then be used to eliminate any potential upgrade offers in 47 that contain the same factor(s) that contributed to the user's decision to decline one or more of the original product offerings.

An example of a scenario featuring this embodiment could demonstrate itself as follows: The user declines to purchase a particular event in 35 because they do not want to attend a concert that features “Mozart” (called the “rejection factor”). A navigation business rule exists in 47 that instructs the system to eliminate any possible upgrade offers from 45 that contain event attributes that match with any of the “rejection factors”. If there is an existing possible upgrade offer that features a piece of music by Mozart, then it will be eliminated as a possible upgrade offer at 47 because it matches one of the rejection factors, in this case—it contains a piece by Mozart.

The next factor used to quantify and validate each of the possible upgrade options is the user's past purchase history, 48. The user's past purchase history is an important factor since it is reasonable to assume that there is a relationship between a user's past purchases and that particular user's propensity to purchase similar items in the future. This relationship is established by comparing the user's stated event attribute preferences in 12 to the event attributes of that particular user's previous purchases (if any) that are stored in a database 56.

This data structure containing the past purchase information is similar to the structure of FIG. 6 but contains all events over the past three years along with their corresponding event attributes, Relevance Scores, Prominence Scores and Attribute Scores. This data structure is organized by ticket buyer name and patron number. If a match occurs between one of the user's preferences, as stated by the user in 12, and one of the event attributes from a previous purchase, then the Attribute Score of that particular event attribute is added to the Upgrade Option Score of each upgrade option that also contains that same event attribute, allowing that particular event attribute to be factored into an upgrade offer.

The purpose of the Upgrade Option Score is to enable the system to quantify and rank the possible upgrade offers. This is another representation of how content based filtering processes and collaborative filtering process are combined to generate purchase recommendations.

For example: In an exemplary embodiment related to music: if “Beethoven” was one of the user's preferences as stated in 12 and the user had previously purchased two Beethoven concerts with Attribute Scores of ‘6’ and ‘9’ respectively, then a score of ‘15’ (6+9) would be added to the scores, as determined in 47, of each of the potential upgrade options that contained a Beethoven piece.

If there is not a potential upgrade option that can be considered the “best” choice, in 49, (i.e. highest Upgrade Option Score with no ties), then the system will proceed to 50. If there is an option that has a larger Upgrade Option Score than all of the other options, then the system will proceed to 53, where this particular option will be selected for presentation to the user.

In 50 the composers in the current shopping cart, in an exemplary embodiment related to music performances, will be compared to the Parallel Database, 55. A Parallel Database is defined as a data structure that contains the relationships between composers (or playwrights in the case of a live theater company) of similar style, genre or other significant artistic distinction. Experts, in their respective artistic fields, for each particular embodiment construct this data structure. It would be at this point that the criteria for comparison would be established. For example: a classical music expert will assist with the development of a data structure that is to be used in a symphony orchestra environment and it would be this expert who could advise upon the various comparison criteria (genre, style, etc.) that should be used for comparing composers. The data structure will cross-reference a particular composer (in the case of a symphony orchestra) with all other composers who compare favorably with respect to genre, style or some other acceptable artistic distinction.

In an exemplary embodiment, the system would electronically access the Parallel Database for the list of cross-references between the first composer of the first piece of music from the first concert in the shopping cart and any other composers noted in the Parallel Database. The system would then electronically compare the list of cross-referenced composers with the all the composers that appear in the upgrade options. Each time an exact match occurs, that particular upgrade option receives a “point”. A “point” is used as a counter for the number of matches with the Parallel Database. These points do not have any relevance to the Attribute Scores, Event Scores or Upgrade Option Scores previously noted. Since, at this point of the process, we have at least two options that have equivalent Upgrade Option Scores, the purpose of the Parallel Database is to determine one single upgrade option that is superior to all others.

In an exemplary embodiment related to music: if the user has a concert that contains a piece by “Beethoven” in their shopping cart, the system would electronically access the Parallel Database for a list of cross-references between “Beethoven” and all other composers. Assuming that the Parallel Database considers Mozart and Beethoven similar in style, genre or some other accepted measure, the system would then search the available upgrade options for any Mozart pieces. The upgrade option with the most number of Mozart pieces would then be considered the preferred upgrade option. This process would continue until all composers noted in the shopping cart had been cross-referenced.

In 51, if a there are two or more options that have equal ranking after this process, the upgrade option with the highest score after step 47 is considered to be the preferred upgrade option as depicted in 54.

At 52, the system has already determined that there isn't more than one upgrade option available to offer to the user. This can occur if a user's shopping cart does not meet any of the upgrade requirements as set forth in the business rules. Since, the system will automatically have a default offer pre-programmed into its memory, this default offer will become the upgrade offer that is made to the user.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims, means-plus-function clause is intended to cover the structures described herein as performing the recited function and not only structural equivalents but also equivalent structures. Thus, although a nail and a screw may not be structural equivalents in that a nail employs a cylindrical surface to secure wooden parts together whereas a screw employs a helical surface, in the environment of fastening wooden parts, a nail and a screw may be equivalent structures.

I claim:

1) A purchase recommendation method for items by a user, comprising the steps of:
a) providing predetermined selections of items for purchase;
b) correlating said predetermined selections of items according to a weighted attribute scale;
c) receiving selected attributes of preference from the user;
d) determining a match between said correlated predetermined selections of items and said received selected attributes of preference from the user; and
e) presenting said determined match to the user for purchase.

2) A purchase recommendation method for items by a user as recited in claim 1 further comprising the steps of:
f) receiving a rejection of said presented determined match by the user; and
g) presenting a subsequent determined match to the user for purchase.

3) A purchase recommendation method for items by a user comprising the steps:
a) providing an event group comprising selected events derived from the user;
b) determining selected recommendations via a preference mapping engine;
c) deriving an event group score from preferences received from the user;
d) organizing said determined selected recommendations according to said event group score; and
e) presenting selected said organized event group to the user for purchase.

4) A purchase recommendation method for items by a user as recited in claim 3 wherein said event group consists of at least one event derived from the user.

5) A purchase recommendation method for items by a user as recited in claim 3 wherein said preference mapping engine consists of the steps:
f) providing a catalog of selected event attributes stored on a database;
g) deriving selected event preferences from the user;
h) comparing selected event attributes and selected event preferences; and
i) deriving a preference map from said derived selected event preferences from the user and said stored selected event attributes.

6) A purchase recommendation method for items by a user as recited in claim 5 wherein said preference map consists of the steps:
j) determining a relevance score denoting selected event attributes;
k) determining a prominence score denoting relative prominence of the selected event attributes;
l) deriving an attribute score, said attribute score defining a quantitative relationship of said relevance score and said prominence score of said selected event attributes stored on said database; and
m) adding said attribute score to said event group score.

7) A purchase recommendation method for items by a user recited in claim 6 wherein said quantitative relationship is the product of said prominence score and said attribute score.

8) A purchase recommendation method for items by a user as recited in claim 3 wherein said events selected from the group consisting of musical concerts, theatrical productions, opera productions and ballet productions.

9) A purchase recommendation method for items by a user as recited in claim 3 wherein said organized selected recommendations are sorted from the highest said event group score to the lowest said event group score.

10) A purchase recommendation method for items by a user as recited in claim 3 further comprising the step of accepting for purchase said selected organized event group by the user.

11) A purchase recommendation method for items by a user as recited in claim 3 further comprising the step of rejecting said selected organized event group by the user.

12) A purchase recommendation method for items by a user as recited in claim 11 wherein the step of rejecting said selected organized event group by the user consists of the steps:
a) presenting a next in sequence of said organized event group to the user;
b) accepting for purchase said next in sequence said organized event group by the user; and
c) terminating the recommendation presentation by the user.

13) A purchase recommendation method for items by a user as recited in claim 11 wherein the step of rejecting said selected organized event group by the user consists of the steps:
d) presenting said selected organized event group to the user;
e) accepting for purchase said selected organized event group by the user; and
f) terminating the recommendation presentation by the user.
